(19) United States
(12) Patent Application Publication
(10) Pub. No.: US 2023/0333228 A1
(43) Pub. Date: Oct. 19, 2023

(54) WALK-OFF COMPENSATION USING A PLANAR LIGHTWAVE CIRCUIT

(71) Applicant: Lumentum Operations LLC, San Jose, CA (US)

(72) Inventors: Christopher DOERR, Middletown, NJ (US); Paul COLBOURNE, Ottawa (CA)

(21) Appl. No.: 17/823,251

(22) Filed: Aug. 30, 2022

Related U.S. Application Data
(60) Provisional application No. 63/362,945, filed on Apr. 13, 2022.

(51) Int. Cl. G01S 7/497; G02B 6/12; G01S 7/481; G01S 7/4861; G01S 7/4913

(52) U.S. Cl. CPC G01S 7/497; G02B 6/12007; G01S 7/4817; G01S 7/4861; G01S 7/4913; G02B 6/29353

(57) ABSTRACT

An optical system may include a scanning element, a detector, and a planar lightwave circuit (PLC)-based walk-off compensator. The PLC-based walk-off compensator may include a plurality of input waveguides associated with receiving an optical signal from the scanning element. The PLC-based walk-off compensator may include an optical switch configured to select one or more input waveguides, from the plurality of input waveguides, to be coupled to the detector. The selection of the one or more input waveguides may be based on an expected walk-off of the optical signal. The PLC-based walk-off compensator may include an output waveguide to provide the optical signal to the detector.

### CROSS-REFERENCE TO RELATED APPLICATION

This Patent application claims priority to U.S. Provisional Patent Application No. 63/362,945, filed on Apr. 13, 2022, and entitled “WALK-OFF COMPENSATION USING A PLANAR LIGHTWAVE CIRCUIT.” The disclosure of the prior Application is considered part of and is incorporated by reference into this Patent Application.

### TECHNICAL FIELD

The present disclosure relates generally to a planar lightwave circuit (PLC) and, more particularly, to a PLC configured to provide walk-off compensation in a scanning optical system.

### BACKGROUND

A scanning optical system, such as a light detection and ranging (LIDAR) system, may include a transmitter to transmit an optical signal and receiver to receive a reflected optical signal (after the optical signal is reflected by a target). For example, an optical signal (e.g., emitted by one or more light sources) can be directed to a scanning element (e.g., such as a micro-electro-mechanical systems (MEMS) mirror), and the scanning element directs the optical signal toward the target about which information (e.g., a distance measurement, a 3D image, and/or the like) is to be ascertained. A position (e.g., a tilt angle) of the scanning element may be controlled such that the scanning element oscillates about an axis (e.g., from left to right to left, and so on), while directing the optical signal toward the target. After reflection by a target, a reflected optical signal is received back at the scanning element. The scanning element provides the reflected optical signal to a detector (e.g., one or more photo diodes) of the scanning optical system. Output signals (e.g., one or more signals corresponding to the received optical signal) provided by the detector can be used to determine a distance to the target. Such information can be used for distance measurement, three-dimensional (3D) imaging, and/or the like.

### SUMMARY

In some implementations, an optical system includes a scanning element; a detector; and a PLC-based walk-off compensator including: a plurality of input waveguides associated with receiving an optical signal from the scanning element, an optical switch configured to select one or more input waveguides, from the plurality of input waveguides, to be coupled to the detector, wherein the selection of the one or more input waveguides is based on an expected walk-off of the optical signal, and an output waveguide to provide the optical signal to the detector.

In some implementations, a method includes determining, by a PLC-based walk-off compensator, a state of an expected walk-off of an optical signal; selecting, by the PLC-based walk-off compensator, one or more waveguides of a plurality of waveguides based on the state of the expected walk-off of the optical signal, wherein a first waveguide of the plurality of waveguides is selected when the expected walk-off is in a first state, and wherein a second waveguide of the plurality of waveguides is selected when the expected walk-off is in a second state; and causing, by the PLC-based walk-off compensator, the optical signal to be provided via the selected one or more waveguides.

In some implementations, a PLC-based walk-off compensator includes a first waveguide and a second waveguide on a first side; a third waveguide on a second side; and an optical switch associated with coupling at least one of the first waveguide or the second waveguide to the third waveguide, wherein the optical switch is configured to select the at least one of the first waveguide or the second waveguide for coupling to the third waveguide based on an expected walk-off of an optical signal.

### BRIEF DESCRIPTION OF THE DRAWINGS

FIG. 1 is a diagram of an optical system including a PLC-based walk-off compensator described herein.

FIGS. 2A-2C are diagrams illustrating an example operation of the optical system including the PLC-based walk-off compensator described herein.

FIGS. 3A and 3B are diagrams illustrating example implementations of the PLC-based walk-off compensator described herein.

FIG. 4 is a diagram illustrating an example insertion losses achievable using the PLC-based walk-off compensator described herein.

FIG. 5 is a flowchart of an example process associated with walk-off compensation using the PLC-based walk-off compensator described herein.

### DETAILED DESCRIPTION

The following detailed description of example implementations refers to the accompanying drawings. The same reference numbers in different drawings may identify the same or similar elements.

In operation of a scanning optical system, such as a LIDAR system, a transmitted optical signal takes some amount of time to travel from a scanning element to a target and back to the scanning element from the target, during which time the scanning element (e.g., a tiltable or rotatable MEMS mirror) rotates or moves in association with performing scanning. As a result, the reflected optical signal provided by the scanning element may be misaligned with respect to an input waveguide of the receiver such that there is some amount of walk-off (e.g., angular shift and/or lateral displacement) of the reflected optical signal at the receiver.

A scanning speed of the scanning element varies approximately sinusoidally over time. At a point in time of a maximum scanning speed in one direction (e.g., a leftward direction), a maximum amount of walk-off in a first direction occurs in the receiver. Further, at a point in time when the scanning element is changing the direction of scanning to another direction (e.g., from the leftward direction to a rightward direction) the scanning speed is approximately zero and, therefore, the walk-off at the receiver is approximately zero. Additionally, at a point in time of a maximum scan speed in the other direction (e.g., the rightward direction), a maximum amount of walk-off in a second (opposite) direction occurs in the receiver. A significant reduction in received optical power can occur if no walk-off compensation is performed. Put another way, as a result of movement of the scanning element during scanning, the receiver of the optical system may not be properly aligned for efficient collection of the reflected optical signal.

Notably, if scanning performed by the optical system is always in the same direction and at the same speed, then a fixed offset between a transmitter of the optical system and the receiver of the optical system could be used to correct for walk-off. However, the optical system may be configured to scan in multiple directions (e.g., in both the leftward direction and the rightward direction) in order to, for example, increase an amount of data collected by the optical system. Therefore, to improve performance of the optical system, it may be desirable for the optical system to collect light efficiently in the presence of walk-off, meaning that walk-off compensation is needed.

Some implementations described herein provide techniques and apparatuses for walk-off compensation using a PLC-based walk-off compensator. In some implementations, an optical system includes a scanning element, a detector, and a PLC-based walk-off compensator. The PLC-based walk-off compensator may include a plurality of input waveguides associated with receiving an optical signal from the scanning element, an optical switch configured to select one or more of the input waveguides to be coupled to the detector, and an output waveguide to provide the optical signal to the detector. Here, the PLC-based walk-off compensator may select the one or more input waveguides from the plurality of waveguides based on an expected walk-off of the optical signal. Additional details are provided below.

In some implementations, the optical switch of the PLC-based walk-off compensator enables one or more input waveguides to couple to the detector at a given time. In some implementations, as the optical signal is scanned back-and-forth in association with performing scanning, the optical switch can be operated in synchronization with the scanning so that appropriate walk-off correction is applied as the walk-off changes throughout scanning due to the varying scanning speed of the scanning element. In this way, the PLC-based walk-off compensator can reduce loss and increase optical power in the optical system by mitigating walk-off (e.g., lateral displacement or angular shift) associated with the reflected optical signal. Notably, while the implementations described herein are described in the context of the PLC-based walk-off compensator being included a receiver of a scanning optical system, these implementations can also be applied for a PLC-based walk-off compensator included in a transmitter of a scanning optical system.

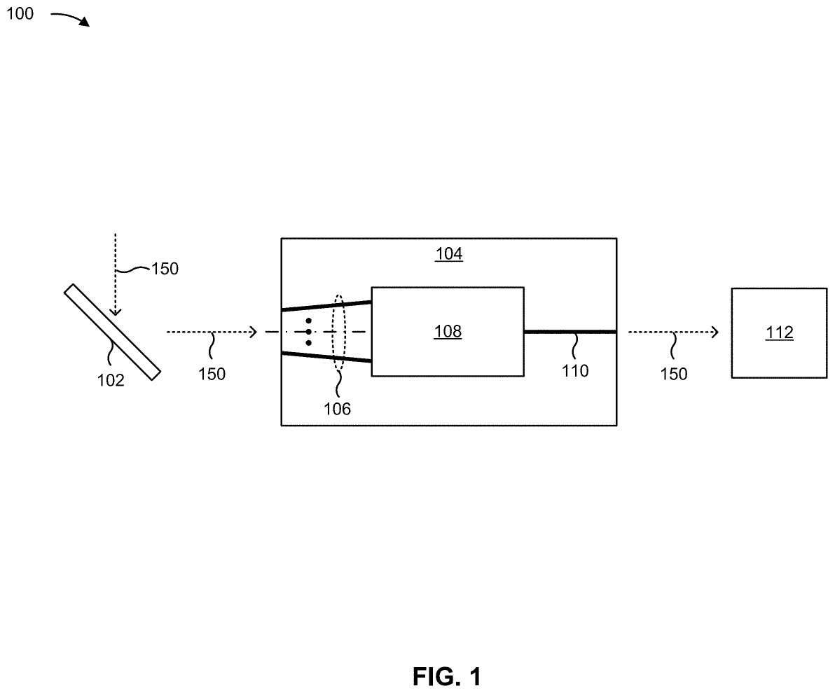

FIG. 1 is a diagram of an optical system 100 including a PLC-based walk-off compensator described herein. As shown in FIG. 1, the optical system 100 may include a scanning element 102, a PLC-based walk-off compensator 104 (including one or more waveguides 106, an optical switch 108, and a waveguide 110), and a detector 112. In some implementations, the optical system 100 may be, for example, a LIDAR system. In some implementations, the optical system 100 may be a coherent LIDAR system because, in a coherent LIDAR system, received light (e.g., the optical signal 150) needs to be coupled into a waveguide (rather being incident on a detector, which could be sized to collect light in the presence of walk-off).

The scanning element 102 includes one or more components to perform scanning for the optical system 100. For example, the scanning element 102 may in some implementations include a movable or rotatable reflector, such as a scanning MEMS mirror. In some implementations, the scanning element 102 is configured to scan back-and-forth in two directions (e.g., left to right, right to left, and so on). In some implementations, a scanning speed of the scanning element 102 varies during approximately sinusoidally during scanning. In some implementations, as shown in FIG. 1, the scanning element 102 may be configured to receive an optical signal 150 (e.g., a reflected optical signal) and provide the optical signal 150 to the PLC-based walk-off compensator 104 such that the optical signal 150 is coupled to one or more waveguides 106 of the PLC-based walk-off compensator 104, as described herein.

In some implementations, the scanning element 102 may provide the optical signal 150 to the PLC-based walk-off compensator 104 via one or more other optical components not shown in FIG. 1, such as one or more lenses. In some implementations, the scanning speed of the scanning element 102 and/or the one or more other optical components via which the scanning element 102 provides the optical signal 150 to the PLC-based walk-off compensator 104 may result in walk-off at the PLC-based walk-off compensator 104 (e.g., a lateral displacement, an angular shift, or a combination of lateral displacement and angular shift).

The PLC-based walk-off compensator 104 includes one or more components capable of providing walk-off compensation for the optical signal 150, as described herein. As shown, the PLC-based walk-off compensator 104 may include a plurality of waveguides 106, an optical switch 108, and a waveguide 110. In some implementations, as illustrated in optical system 100, the PLC-based walk-off compensator 104 is included in a receiver of an optical system. Alternatively, in some implementations, the PLC-based walk-off compensator 104 may be included in a transmitter of an optical system.

The plurality of waveguides 106 is a group of waveguides associated with receiving the optical signal 150 from the scanning element 102. As shown in FIG. 1, waveguides 106 in the plurality of waveguides 106 may in some implementations be angled with respect to one another. In some implementations, angling a given waveguide 106 with respect to one another enables mitigation of walk-off that is a combination of lateral displacement and angular shift. Further, waveguides 106 in the plurality of waveguides 106 may in some implementations be laterally displaced with respect to a reference point (e.g., point at which the optical signal 150 would be incident on the PLC-based walk-off compensator 104 absent any walk-off). For example, as shown in FIG. 1, waveguides 106 in the plurality of waveguides 106 may be laterally displaced with respect to a midpoint of a distance between outermost waveguides 106 in the plurality of waveguides 106. In some implementations, lateral displacement of the waveguides 106 enables mitigation of walk-off for scanning in different directions (e.g., scanning in a leftward direction and scanning in a rightward direction) to improve coupling efficiency. The waveguide 110 is a waveguide to provide the optical signal 150, provided via the one or more waveguides 106 selected by the optical switch 108, to the detector 112.

The optical switch 108 is a component to select one or more of the waveguides 106 to be coupled to the detector 112. For example, in some implementations, the optical signal 150 includes a Mach-Zehnder (MZ) interferometer with one or more phase shifters arranged on one or more arms of the MZ interferometer.

In some implementations, the PLC-based walk-off compensator 104 (e.g., the optical switch 108) selects the one or more waveguides 106 based on an expected walk-off of the optical signal 150. For example, the PLC-based walk-off compensator 104 may in some implementations be configured to determine a state of the expected walk-off of the optical signal 150 and select one or more of the waveguides 106 based on the state of the expected walk-off of the optical signal 150. The PLC-based walk-off compensator 104 may then cause the optical signal 150 to be provided via the one or more selected waveguides 106.

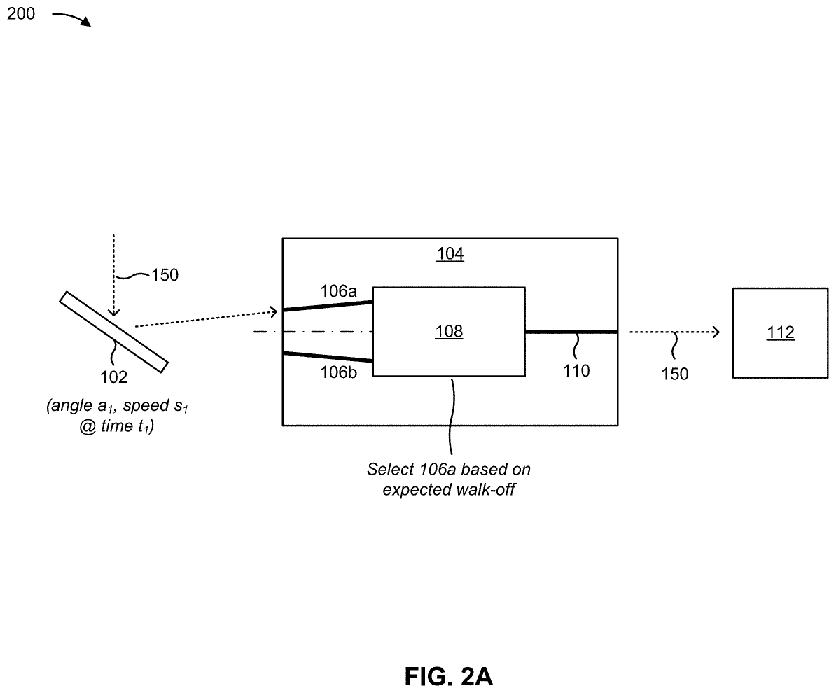

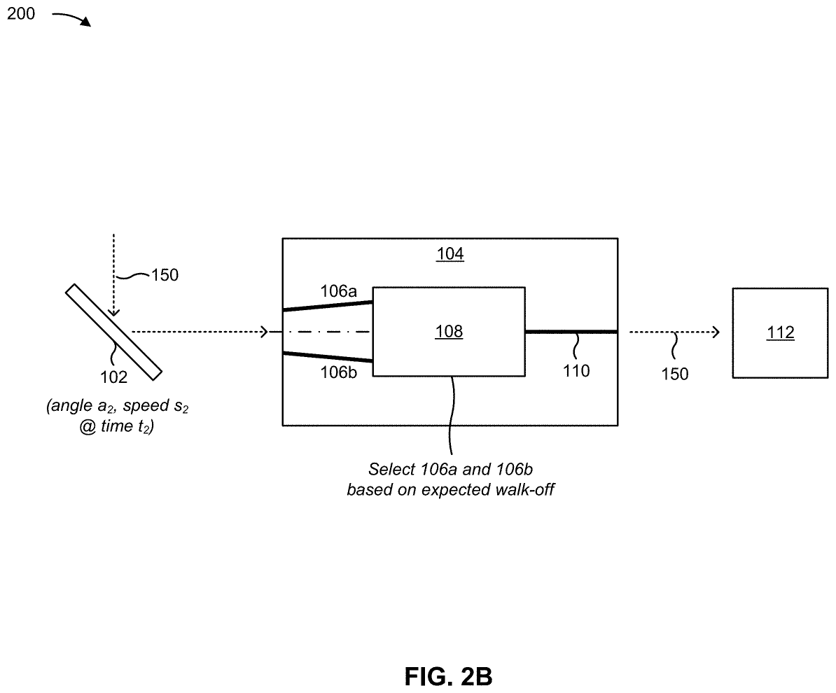

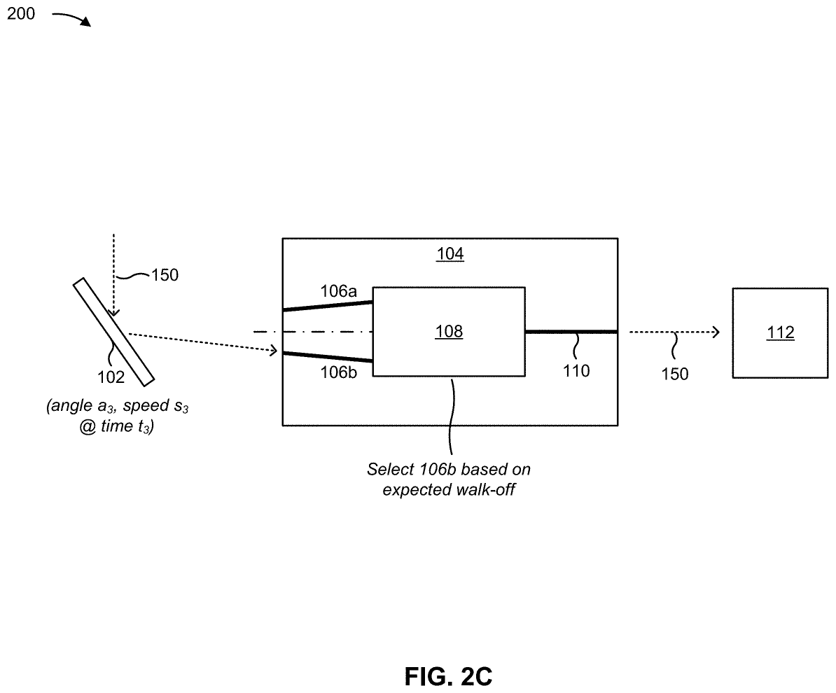

In some implementations, the PLC-based walk-off compensator 104 may determine the expected walk-off based on a direction of movement of the scanning element 102 or a speed of movement of the scanning element 102. For example, the PLC-based walk-off compensator 104 (e.g., a control circuit of the optical switch 108) may receive, from a controller associated with the scanning element 102 (not shown) information that indicates the direction of the movement of the scanning element 102 (e.g., leftward, rightward, or the like) and a speed of movement (e.g., a maximum scanning speed in the direction of movement, half of the maximum scanning speed in the direction of movement, a current speed in the direction of movement, or the like) of the scanning element 102. The PLC-based walk-off compensator 104 may, based on the direction of movement or the speed of movement, calculate an expected walk-off (e.g., an expected lateral displacement or angular shift) of the optical signal 150 at an input surface of the PLC-based walk-off compensator 104 (e.g., the left surface of the PLC-based walk-off compensator 104 in FIG. 1). The PLC-based walk-off compensator 104 may then select the one or more waveguides 106 based on the expected walk-off such that walk-off of the optical signal 150 is at least partially mitigated. An example operation of the PLC-based walk-off compensator 104 is described below with respect to FIGS. 2A-2C.

In some implementations, the PLC-based walk-off compensator 104 is configured to provide walk-off correction that corresponds to an amount of walk-off that would occur at half of a maximum scanning speed in a given direction. In such a case, the received optical power can be improved (e.g., as compared to no walk-off correction being applied). Notably, by selecting a walk-off compensation corresponding to half the maximum scanning speed, the maximum misalignment due to walk-off can be reduced by half, resulting in one-quarter the optical power loss due to walk-off, since optical power loss has an approximately quadratic relationship with the misalignment. In some implementations, if the scanning speed is substantially constant in each direction, the walk-off penalty can be effectively reduced to zero for a given target distance.

The detector 112 includes one or more components to receive the optical signal 150 and convert the optical signal 150 to an electrical signal (e.g., a current). For example, the detector 112 may include one or more photodetectors, such as a photodiode. In some implementations, the optical signal 150 is coupled from the waveguide 110 of the PLC-based walk-off compensator 104 to the detector 112.

As indicated above, FIG. 1 is provided as an example. Other examples may differ from what is described with regard to FIG. 1. The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more functions described as being performed by another set of components shown in FIG. 1.

FIGS. 2A-2C are diagrams illustrating an example operation 200 of the optical system 100 including the PLC-based walk-off compensator 104.

As shown in FIG. 2A, at a first point in time (t₁), the PLC-based walk-off compensator 104 determines that the scanning element 102 is at a first angular position (a₁) and is moving at a first scanning speed (s₁). Here, the PLC-based walk-off compensator 104 (e.g., the optical switch 108) determines that that the expected walk-off is in a first state (e.g., such that the optical signal 150 is expected to be incident at a point nearer to an input of the waveguide 106a and angled toward the input of the waveguide 106a). Thus, as shown in FIG. 2A, the PLC-based walk-off compensator 104 may select the waveguide 106a based on the expected walk-off of the optical signal 150 being in the first state. In this scenario, the PLC-based walk-off compensator 104 causes the optical signal 150 to be provided via the waveguide 106a. In one particular example, in the case of an MZ interferometer, the waveguide 106a can be selected when a first phase shift (e.g., a 0 degree)(° phase shift) is applied at the optical switch 108.

As shown in FIG. 2B, at a second point in time (t₂) (e.g., a later point in time as the scanning element 102 rotates in association with performing scanning), the PLC-based walk-off compensator 104 determines that the scanning element 102 is at a second angular position (a₂) and is moving at a second scanning speed (s₂). Here, the PLC-based walk-off compensator 104 (e.g., the optical switch 108) determines that that the expected walk-off is in a second state (e.g., such that the optical signal 150 is expected to be incident near a midpoint between the input of the waveguide 106a and an input of a waveguide 106b at an angle approximately normal to the input surface of the PLC-based walk-off compensator 104). Thus, as shown in FIG. 2B, the PLC-based walk-off compensator 104 may select both the waveguide 106a and the waveguide 106b based on the expected walk-off of the optical signal 150 being in the second state. In this scenario, the PLC-based walk-off compensator 104 causes the optical signal 150 to be provided via both the waveguide 106a and the waveguide 106b. In one particular example, in the case of the MZ interferometer, both the waveguide 106a and the waveguide 106b can be selected when a second phase shift (e.g., a 90° phase shift) is applied at the optical switch 108. Notably, when the optical signal 150 is approximately midway between the first waveguide and the second waveguide, optical power coupled to the detector is nearly independent of the phase setting, meaning that the phase shifter can switch from accepting light from the first waveguide to accepting light from the second waveguide without significant loss.

As shown in FIG. 2C, at a third point in time (t₃), the PLC-based walk-off compensator 104 determines that the scanning element 102 is at a third angular position (a₃) and is moving at a third scanning speed (s₃). Here, the PLC-based walk-off compensator 104 (e.g., the optical switch 108) determines that that the expected walk-off is in a third state (e.g., such that the optical signal 150 is expected to be incident at a point nearer to an input of the waveguide 106b and angled toward the input of the waveguide 106b). Thus, as shown in FIG. 2C, the PLC-based walk-off compensator 104 may select the waveguide 106b based on the expected walk-off of the optical signal 150 being in the third state. In this scenario, the PLC-based walk-off compensator 104 causes the optical signal 150 to be provided via the waveguide 106b. In one particular example, in the case of the MZ interferometer, the waveguide 106b can be selected when a third phase shift (e.g., a 180° phase shift) is applied at the optical switch 108.

In some implementations, the PLC-based walk-off compensator 104 may continue operation in this manner by, for example, periodically determining updated states of the expected walk-off of the optical signal 150, and selecting the waveguide 106a and/or the waveguide 106b accordingly (e.g., to perform continuous monitoring and mitigation of the expected walk-off). In this way, different sets of one or more waveguides 106 can be selected so as to reduce loss and increase optical power in a scenario in which the optical signal 150 is shifted due to walk-off (e.g., lateral displacement and/or angular shift).

As indicated above, FIGS. 2A-2C are provided as examples. Other examples may differ from what is described with regard to FIGS. 2A-2C. The number and arrangement of components shown in FIGS. 2A-2C are provided as examples. In practice, there may be additional components, fewer components, different components, or differently arranged components than those shown in FIGS. 2A-2C. Furthermore, two or more components shown in FIGS. 2A-2C may be implemented within a single component, or a single component shown in FIGS. 2A-2C may be implemented as multiple, distributed components. Additionally, or alternatively, a set of components (e.g., one or more components) shown in FIGS. 2A-2C may perform one or more functions described as being performed by another set of components shown in FIGS. 2A-2C.

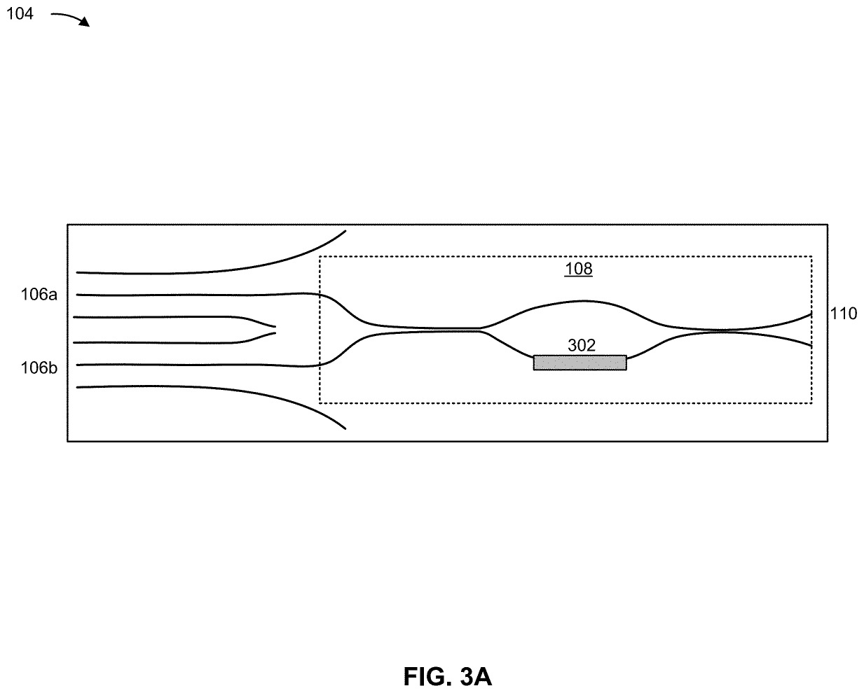

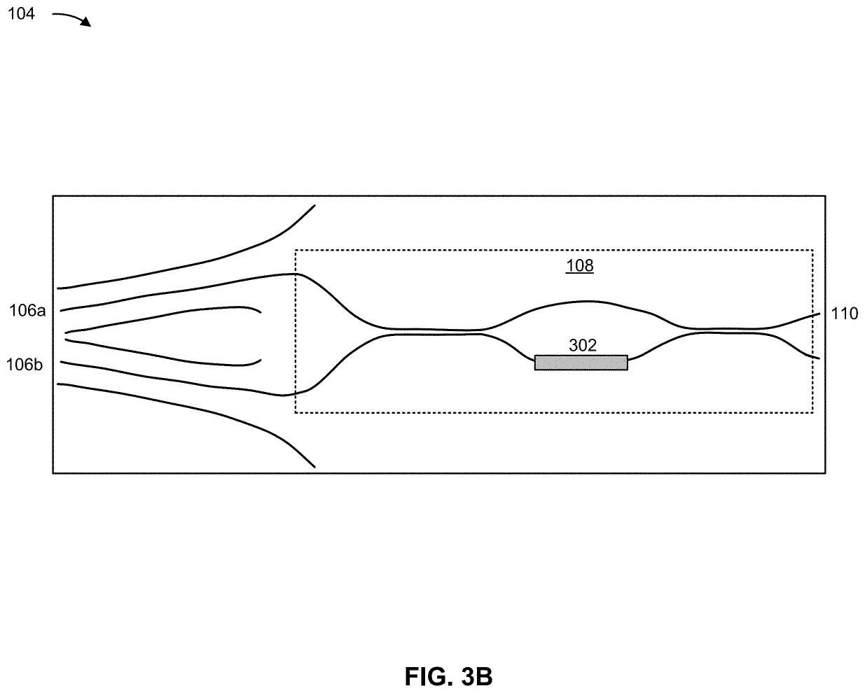

FIGS. 3A and 3B are diagrams illustrating example implementations of the PLC-based walk-off compensator 104. As shown in FIGS. 3A and 3B, the PLC-based walk-off compensator 104 may in some implementations be implemented using an MZ interferometer. In the case of an MZ interferometer, the PLC-based walk-off compensator 104 may include one or more phase shifters 302 on one or more arms of the MZ interferometer. For example, as shown in FIGS. 3A and 3B, the PLC-based walk-off compensator 104 may in some implementations include one phase shifter 302 on one arm the MZ interferometer. Notably, other implementations are possible. For example, in some implementations, the PLC-based walk-off compensator 104 may include a first phase shifter 302 on a first arm and a second phase shifter 302 on a second arm. In some implementations, as noted above and illustrated in FIG. 3B, the waveguides 106 may be angled with respect to one another, which enables mitigation of walk-off that is a combination of lateral displacement and angular shift.

In FIGS. 3A and 3B, waveguides 106a and 106b can couple the optical signal 150, and the MZ interferometer optical switch 108 has a phase shifter 302 to couple waveguide 106a and/or waveguide 106b to the detector 114 (not shown) connected to waveguide 110. IN one example, waveguide 106a can be selected with a 0° phase shift, and waveguide 106b can be selected with a 180° phase shift. Additionally, or alternatively, the phase shifter 302 can be set at 90° to couple light from both waveguides 106a and 106b, which may be advantageous when the optical signal 150 is expected to be incident on the PLC-based walk-off compensator 104 between the waveguides 106a and 106b. Advantageously, when the beam falls approximately midway between the waveguides 106a and 106b, optical power coupled to the detector 112 is nearly independent of the phase setting, meaning that the phase shifter 302 can smoothly switch from accepting light from the waveguide 106a to the waveguide 106b without loss of signal.

As indicated above, FIGS. 3A and 3B are provided as examples. Other examples may differ from what is described with regard to FIGS. 3A and 3B. The number and arrangement of components shown in FIGS. 3A and 3B are provided as an example. In practice, there may be additional components, fewer components, different components, or differently arranged components than those shown in FIGS. 3A and 3B.

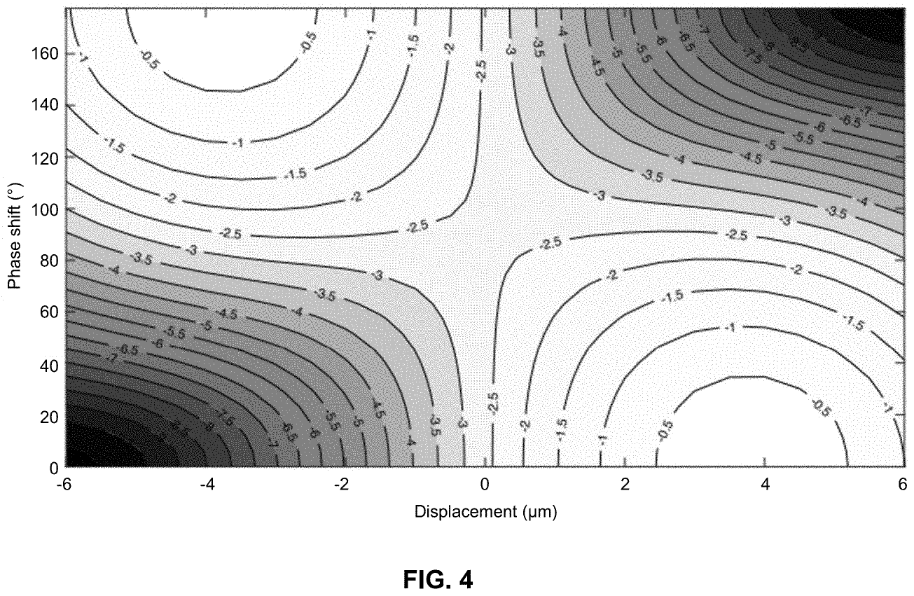

FIG. 4 is a diagram illustrating example insertion losses achievable using the PLC-based walk-off compensator 104. In FIG. 4, lateral displacement of the optical signal 150 is shown on the horizontal axis, an applied phase shift is shown in the vertical axis, and the contours represent insertion loss.

In one example illustrated by FIG. 4, low insertion loss can be achieved for a 4 micron (μm) lateral displacement using a 0° phase shift. Similarly, low insertion loss can be achieved for a −4 μm lateral displacement using a 180° phase shift. Notably, if the PLC-based walk-off compensator 104 is configured so as to provide walk-off compensation corresponding to an amount of walk-off that would occur at half of a maximum scanning speed in a given direction.

In some implementations, the PLC-based walk-off compensator 104 is configured to provide walk-off correction that corresponds to an amount of walk-off that would occur at half of a maximum scanning speed in a given direction, as described above. In such a case, the example shown in FIG. 4 would correspond to an optical system 100 in which a maximum of ±8 μm is expected.

As indicated above, FIG. 4 is provided as an example. Other examples may differ from what is described with regard to FIG. 4.

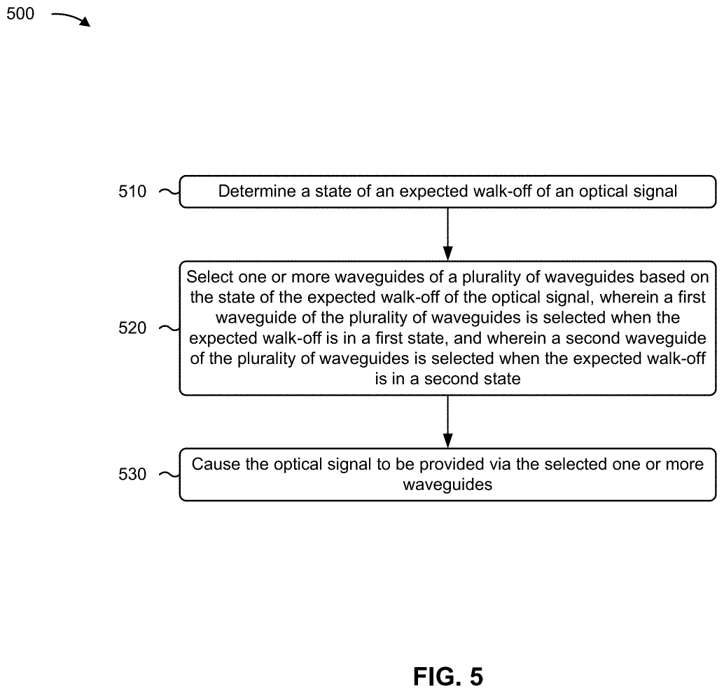

FIG. 5 is a flowchart of an example process 500 associated with walk-off compensation using a PLC. In some implementations, one or more process blocks of FIG. 5 are performed by a PLC-based walk-off compensator (e.g., PLC-based walk-off compensator 104).

As shown in FIG. 5, process 500 may include determining a state of an expected walk-off of an optical signal (block 510). For example, the PLC-based walk-off compensator may determine a state of an expected walk-off of an optical signal, as described above.

As further shown in FIG. 5, process 500 may include selecting one or more waveguides of a plurality of waveguides based on the state of the expected walk-off of the optical signal, wherein a first waveguide of the plurality of waveguides is selected when the expected walk-off is in a first state, and wherein a second waveguide of the plurality of waveguides is selected when the expected walk-off is in a second state (block 520). For example, the PLC-based walk-off compensator may select one or more waveguides of a plurality of waveguides based on the state of the expected walk-off of the optical signal, wherein a first waveguide of the plurality of waveguides is selected when the expected walk-off is in a first state, and wherein a second waveguide of the plurality of waveguides is selected when the expected walk-off is in a second state, as described above.

As further shown in FIG. 5, process 500 may include causing the optical signal to be provided via the selected one or more waveguides (block 530). For example, the PLC-based walk-off compensator may cause the optical signal to be provided via the selected one or more waveguides, as described above.

Process 500 may include additional implementations, such as any single implementation or any combination of implementations described below and/or in connection with one or more other processes described elsewhere herein.

In a first implementation, the first waveguide and the second waveguide are selected when the expected walk-off is in a third state.

In a second implementation, alone or in combination with the first implementation, the optical signal is caused to be provided via the selected one or more waveguides by applying a phase shift to one or more waveguides in an optical switch.

In a third implementation, alone or in combination with one or more of the first and second implementations, process 500 includes determining an updated state of the expected walk-off of the optical signal, selecting at least one waveguide of the plurality of waveguides based on the updated state of the expected walk-off of the optical signal, and causing the optical signal to be provided via the selected at least one waveguide.

In a fourth implementation, alone or in combination with one or more of the first through third implementations, the state of the optical signal indicates at least one of a lateral displacement of the optical signal or an angular shift of the optical signal.

In a fifth implementation, alone or in combination with one or more of the first through fourth implementations, the PLC-based walk-off compensator is included in a transmitter of an optical system.

In a sixth implementation, alone or in combination with one or more of the first through fifth implementations, the PLC-based walk-off compensator is included in a receiver of an optical system.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical system, comprising:
a scanning element;
a detector; and
a planar lightwave circuit (PLC)-based walk-off compensator including:
a plurality of input waveguides associated with receiving an optical signal from the scanning element,
an optical switch configured to select one or more input waveguides, from the plurality of input waveguides, to be coupled to the detector,
wherein the selection of the one or more input waveguides is based on an expected walk-off of the optical signal, and
an output waveguide to provide the optical signal to the detector.

2. The optical system of claim 1, wherein the optical switch includes a Mach-Zehnder (MZ) interferometer with one or more phase shifters arranged on one or more arms of the MZ interferometer.

3. The optical system of claim 2, wherein the optical switch is configured such that:
a first input waveguide of the plurality of input waveguides is selected when a first phase shift is applied,
a second input waveguide of the plurality of input waveguides is selected when a second phase shift is applied, and
both the first input waveguide and the second input waveguide are selected when a third phase shift is applied.

4. The optical system of claim 1, wherein the expected walk-off of the optical signal is based on at least one of a direction of movement of the scanning element or a speed of movement of the scanning element.

5. The optical system of claim 1, wherein input waveguides in the plurality of input waveguides are angled with respect to one another.

6. The optical system of claim 1, wherein the plurality of input waveguides are laterally displaced with respect to a reference point of the PLC-based walk-off compensator.

7. The optical system of claim 1, wherein the optical system is a light detection and ranging (LIDAR) system.

8. A method, comprising:
determining, by a planar lightwave circuit (PLC)-based walk-off compensator, a state of an expected walk-off of an optical signal;
selecting, by the PLC-based walk-off compensator, one or more waveguides of a plurality of waveguides based on the state of the expected walk-off of the optical signal,
wherein a first waveguide of the plurality of waveguides is selected when the expected walk-off is in a first state, and
wherein a second waveguide of the plurality of waveguides is selected when the expected walk-off is in a second state; and
causing, by the PLC-based walk-off compensator, the optical signal to be provided via the selected one or more waveguides.

9. The method of claim 8, wherein the first waveguide and the second waveguide are selected when the expected walk-off is in a third state.

10. The method of claim 8, wherein the optical signal is caused to be provided via the selected one or more waveguides by applying a phase shift to one or more waveguides in an optical switch.

11. The method of claim 8, further comprising:
determining an updated state of the expected walk-off of the optical signal;
selecting at least one waveguide of the plurality of waveguides based on the updated state of the expected walk-off of the optical signal; and
causing the optical signal to be provided via the selected at least one waveguide.

12. The method of claim 8, wherein the state of the optical signal indicates at least one of a lateral displacement of the optical signal or an angular shift of the optical signal.

13. The method of claim 8, wherein the PLC-based walk-off compensator is included in a transmitter of an optical system.

14. The method of claim 8, wherein the PLC-based walk-off compensator is included in a receiver of an optical system.

15. A planar lightwave circuit (PLC)-based walk-off compensator, comprising:
a first waveguide and a second waveguide on a first side;
a third waveguide on a second side; and
an optical switch associated with coupling at least one of the first waveguide or the second waveguide to the third waveguide,
wherein the optical switch is configured to select the at least one of the first waveguide or the second waveguide for coupling to the third waveguide based on an expected walk-off of an optical signal.

16. The PLC-based walk-off compensator of claim 15, wherein the optical switch includes a Mach-Zehnder (MZ) interferometer with one or more phase shifters arranged on one or more arms of the MZ interferometer.

17. The PLC-based walk-off compensator of claim 16, wherein the optical switch is configured such that:
the first waveguide is selected when a first phase shift is applied,
the second waveguide is selected when a second phase shift is applied, and
both the first waveguide and the second waveguide are selected when a third phase shift is applied.

18. The PLC-based walk-off compensator of claim 15, wherein the expected walk-off of the optical signal is based on at least one of a direction of movement of a scanning element or a speed of movement of the scanning element.

19. The PLC-based walk-off compensator of claim 15, wherein the first waveguide and the second waveguide are angled with respect to one another.

20. The PLC-based walk-off compensator of claim 15, wherein the first waveguide and the second waveguide are laterally displaced with respect to a reference point of the PLC-based walk-off compensator.
